(19) United States
(12) Patent Application Publication
(10) Pub. No.: US 2024/0180053 A1
(43) Pub. Date: Jun. 6, 2024

(54) Gardening Tools and Methods for Making Gardening Tools

(71) Applicant: Avellina Enterprises, LLC, Cedar Falls, IA (US)

(72) Inventor: Youri K. Dimitrov, Cedar Falls, IA (US)

(21) Appl. No.: 18/061,088

(22) Filed: Dec. 2, 2022

(51) Int. Cl. A01B 1/00

(52) U.S. Cl. CPC A01B 1/00

(57) ABSTRACT

Example embodiments relate to gardening tools and techniques for making gardening tools. An example garden tool may include an elongated handle with a first end and a second end and a gardening head configured to form a hole in a ground surface. The gardening head includes an upper portion and a lower portion. The upper portion of the gardening head is positioned proximate the second end of the elongated handle and has an inverted frustum configuration. The lower portion of the gardening head includes a rounded conical tip that can form holes according to designed dimensions for planting seeds or plants. In some examples, the garden tool includes multiple gardening heads for creating holes concurrently.

### BACKGROUND

Gardening is the practice of growing and cultivating plants as part of horticulture and typically involves the use of shovels and other gardening tools. In general, a shovel can be used to dig and move dirt or other types of loose, granular materials, such as gravel, grain, and snow. As such, the shovel can reduce the amount of force required from a user through its combination of a lever and a wedge. In particular, the shovel's handle acts as the lever while the bottom attachment of the shovel serves as the wedge that lifts the material (e.g., dirt) from the ground. Gardeners use shovels to dig holes for seeds or plants to be placed. When using the shovel, the dirt initially dug up by the shovel typically needs to be placed somewhere else in order to create a hole before the seed and/or plant can be deposited into the hole.

### SUMMARY

Examples disclosed herein relate to gardening tools that enable the displacement of dirt or other materials to form compact holes in the ground surface. Such tools have a physical structure that pushes dirt aside to create a hole rather than requiring the user (or machine) to lift and remove the dirt when creating the hole for a seed and/or plant. With such configurations, disclosed garden tools are designed to produce predefined holes that have a size and a depth that fits the needs of seeds or plants without requiring the user to exert the additional time and energy associated with lifting and displacing dirt as required when using a typical shovel.

In one aspect, an example garden tool is described. The garden tool includes an elongated handle with a first end and a second end and a gardening head configured to form a hole in a ground surface. The gardening head includes an upper portion and a lower portion. The upper portion of the gardening head is positioned proximate the second end of the elongated handle and has an inverted frustum configuration. The lower portion of the gardening head includes a rounded conical tip.

In another aspect, an example garden tool configured to form a plurality of holes concurrently is described. The garden tool includes an elongated handle having a first end and a second end and a footplate. A portion of a top surface of the footplate is coupled to the second end of the elongated handle. The garden tool also includes a gardening platform. A portion of a top surface of the gardening platform is coupled to a bottom surface of the footplate and a bottom surface of the platform includes an array of gardening heads positioned to form holes concurrently in a ground surface.

In yet another aspect, a method of forming a garden tool is disclosed. The method involves forming a gardening head having an upper portion and a lower portion. The gardening head is configured to form a hole in a ground surface. The upper portion of the gardening head is formed having an inverted frustum configuration, and the lower portion of the gardening head is formed with a rounded conical tip. The method further involves coupling the gardening head to an elongated handle having a first end and a second end. The upper portion of the gardening head is coupled proximate the second end of the elongated handle.

These as well as other aspects, advantages, and alternatives will become apparent to those of ordinary skill in the art by reading the following detailed description, with reference, where appropriate, to the accompanying drawings.

### BRIEF DESCRIPTION OF THE DRAWINGS

FIG. 1 depicts a garden tool for forming holes, according to one or more example embodiments.

FIG. 2 depicts a handheld garden tool, according to one or more example embodiments.

FIG. 3 depicts a garden tool having a foot loop, according to one or more example embodiments.

FIG. 4A depicts a garden tool for forming multiple holes concurrently, according to one or more example embodiments.

FIG. 4B shows another view of the garden tool shown in FIG. 4A, according to one or more example embodiments.

FIG. 5 depicts a block diagram of a method for forming disclosed garden tools, according to one or more example embodiments.

### DETAILED DESCRIPTION

Example methods and systems are contemplated herein. Any example embodiment or feature described herein is not necessarily to be construed as preferred or advantageous over other embodiments or features. Further, the example embodiments described herein are not meant to be limiting. It will be readily understood that certain aspects of the disclosed systems and methods can be arranged and combined in a wide variety of different configurations, all of which are contemplated herein.

In addition, the particular arrangements shown in the figures should not be viewed as limiting. It should be understood that other embodiments might include more or less of each element shown in a given figure. Additionally, some of the illustrated elements may be combined or omitted. Yet further, an example embodiment may include elements that are not illustrated in the figures.

Example embodiments presented herein relate to gardening tools for forming compact holes in dirt and other ground surface materials and techniques for making the gardening tools. Such garden tools have a physical structure that engages and pushes dirt aside to create a hole rather than requiring the user (or machine) to lift and remove the dirt. With these unique configurations, the disclosed garden tools are designed to produce predefined holes that have a size and a depth that fits the needs of seeds or plants without requiring the user to exert the additional time and energy associated with lifting and displacing dirt as required when using a typical shovel.

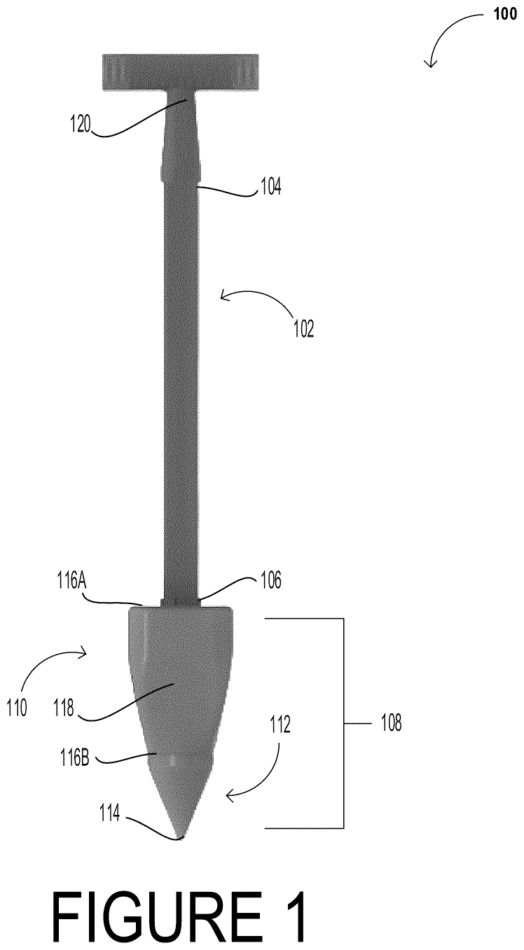

Referring now to the Figures, FIG. 1 illustrates a garden tool 100 as a first example configuration. As shown in the example embodiment, the garden tool 100 includes an elongated handle 102 with a first end 104 and a second end 106. The garden tool 100 also includes a gardening head 108, which is configured to form a hole in a ground surface. The garden tool 100 can have other configurations in other example embodiments. For instance, the size, materials, and arrangement of components of the garden tool 100 can differ in other examples.

The garden tool 100 is shown as a mechanical structure designed to form holes in dirt or other materials when a user applies downward force to drive the gardening head 108 downward into the dirt and rotational force to the gardening head 108 thereby pushing the dirt (or other material) to the sides as a hole is formed. The shape and size of the gardening head 108 enables holes to be formed without requiring the user to scoop and removing dirt like traditional shovels typically require. As shown in FIG. 1, the garden tool 100 includes an elongated handle 102, which can be held by a user of the garden tool 100. The length, width, and material of the elongated handle 102 can vary within examples. For instance, the elongated handle 102 can have a length similar to shovels in some cases. In some embodiments, the length of the elongated handle 102 can be extended or decreased. One or more grip pads can be placed on the elongated handle 102 to increase comfort and grip for a user. The gardening head 108 of the garden tool 100 is shown attached to the elongated handle 102. In particular, the upper portion 110 of the gardening head 108 can attach to the second end 106 of the elongated handle 102 via a fastener, adhesive, and/or other means.

In the example embodiment shown in FIG. 1, the gardening head 108 can be further described as having an upper portion 110 and a lower portion 112. These portions can be a single integral piece in some example implementations or a combination of multiple pieces in other example implementations. For instance, the upper portion 110 and the lower portion 112 can be a single piece of metal, wood, alloys, or other materials. The gardening head 108 as well as other components of the garden tool 100 can be formed using additive manufacturing and/or other manufacturing techniques. When the upper portion 110 and the lower portion 112 are multiple pieces, they can attached together via various means within examples, such as adhesives or fastening materials.

In addition, the upper portion 110 and the lower portion 112 can be different materials in some cases. For instance, the upper portion 110 can be a first type of flexible material and the lower portion 112 can be a rigid material designed to maintain structure when engaging dirt and other materials. Within the garden tool 100, the upper portion 110 of the gardening head 108 is shown positioned proximate the second end 106 of the elongated handle 102 and has an inverted frustum configuration and the lower portion 112 of the gardening head 108 is shown with a rounded conical tip 114. The inverted frustum configuration of the upper portion 110 of the gardening head 108 includes a top surface 116A and a bottom surface 116B such that a surface area of the top surface 116A is greater than a surface area of the bottom surface 116B and so that an exterior surface 118 of the upper portion 110 tapers from the top surface to the bottom surface.

In some embodiments, the inverted frustum configuration of the upper portion 110 includes a pyramidal frustum shape. The pyramidal frustum shape of the inverted frustum configuration of the upper portion 110 may aid a user in digging an appropriate sized hole without exerting too much force because the cross-sectional area of the upper portion 110 tapers larger at a consistent rate as the garden tool 100 is forced into the ground surface. This allows the surrounding dirt to be displaced further from the center of the first point of contact of the garden tool 100 with the ground surface at a consistent rate as the garden tool 100 is forced further into the ground surface. This configuration may also be particularly convenient when desiring to plant a plant that is sold in a temporary pot having a similar pyramidal frustum shape. In other embodiments, the inverted frustum configuration of the upper portion 110 includes a conical frustum shape. Similarly, a conical frustum shape allows for a hole that is slowly enlarging in diameter as the garden tool 100 is forced further into the ground surface. In some embodiments, the upper portion 110 is solid throughout. In other embodiments, the upper portion 110 is hollow. The gardening head 108 is made of wood, metal, or plastic material in some embodiments.

In some embodiments, the garden tool 100 is aligned such that the center of the elongated handle 102, the center of the upper portion 110 of the gardening head 108, and the center of the lower portion 112 of the gardening head 108 are arranged concentrically. In addition, in some of the examples, the upper portion 110 of the gardening head 108 is cuboidal in structure, the elongated handle 102 is cylindrical in structure, and the width of the cuboidal structure is greater in length than the length of the diameter of the cylindrical structure. Further, in some embodiments, a width of the cuboidal structure is greater than a diameter of the lower portion 112 of the gardening head 108.

In some embodiments, the garden tool 100 can further include a grip 120 coupled to the first end 104 of the elongated handle 102. The grip 120 can be used by the user to rotate the gardening head 108 when forming a hole with the garden tool 100. Rotation of the gardening head 108 can produce a round hole, which can be useful when a plant has a round container prior to planting. The grip 120 can be “D”-shaped, “T”-shaped, “l”-shaped, rectangular, round, or the like. Other types of grips and handles can be included on the garden tool 100 and other garden tools described herein.

In some embodiments, as shown in FIG. 1, the garden tool 100 can include a two-piece structure. For instance, the garden tool 100 could include a “T”-shaped grip 120 made of a first material that is coupled with an elongated handle 102 and a gardening head 108 of a second material. In some embodiments, the first material and the second material are the same. In other embodiments, the first material and the second material are different. In some embodiments of the garden tool 100, the upper portion 110 of the gardening head 108 and the lower portion 112 of the gardening head 108 are formed as a single-piece, integral structure.

In some embodiments of FIG. 1, the garden tool 100 could be configured to be mechanically-driven by a machine. For instance, a robotic device or a construction vehicle may apply force when using the garden tool 100 to create holes in some embodiments.

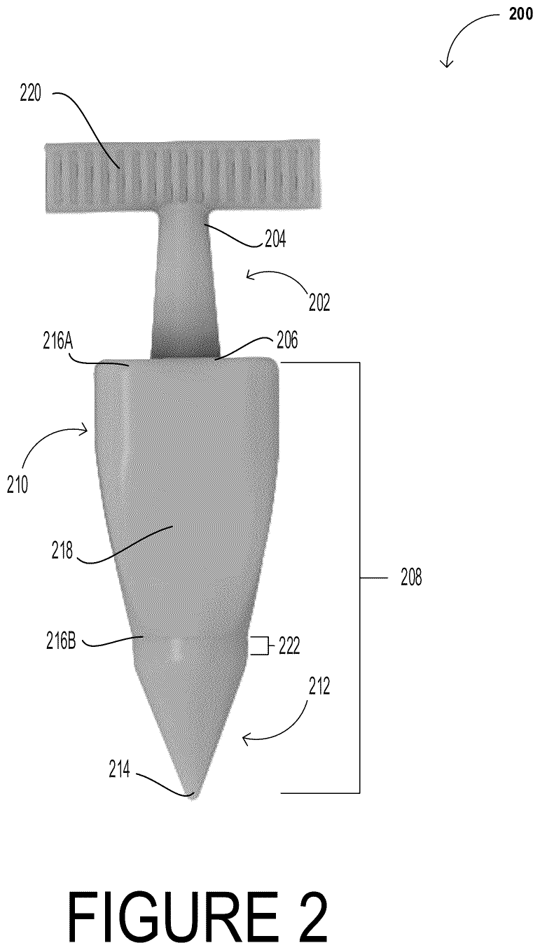

FIG. 2 illustrates a handheld garden tool 200. Similar to the garden tool 100 shown in FIG. 1, the handheld garden tool 200 also includes an elongated handle 202 that has a first end 204 and a second end 206 and a gardening head 208 for forming holes in various types of materials. The elongated handle 202 and the gardening head 208 can include any features of the elongated handle 102 and the gardening head 108 as described in FIG. 1.

Turning to the figure, the handheld gardening head 208 similarly includes an upper portion 210 that is positioned proximate the second end 206 of the elongated handle 202 and is shown with an inverted frustum configuration. The upper portion 210 of the gardening head 208 includes a top surface 216A and a bottom surface 216B such that a surface area of the top surface 216A is greater than a surface area of the bottom surface 216B and so that an exterior surface 218 of the upper portion 210 tapers from the top surface to the bottom surface.

The handheld gardening head 208 also has a lower portion 212. The lower portion 212 of the gardening head 208 includes a rounded conical tip 214. In some embodiments, the garden tool 200 includes a cylindrical section 222 that is positioned between the bottom surface 216B of the upper portion 210 of the gardening head 208 and the rounded conical tip 214.

In some embodiments, the handheld garden tool 200 can further include a grip 220 coupled to the first end 204 of the elongated handle 202. In some embodiments, the garden tool 200 can be a one-piece structure. As such, the garden tool 200 can includes a “T”-shaped grip 220, an elongated handle 202, and a gardening head 208 that are formed as a single-piece, integral structure.

The garden tool 200 may be convenient for a user who prefers gardening on their knees, or in gardening beds that are elevated off of the ground. For instance, it would be difficult to use an elongated handle such as the elongated handle 102 to form a hole in a ground surface when the ground surface is in an elevated flower pot. Instead, the elongated handle 202, as depicted in FIG. 2, having a shorter length than the elongated handle 102 depicted in FIG. 1, is more easily able to be used in such scenarios.

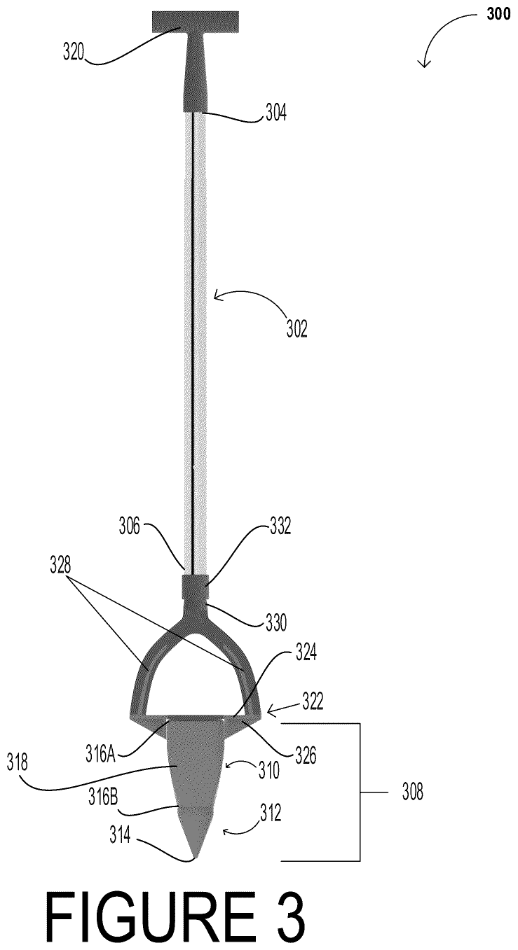

Similarly, in FIG. 3, garden tool 300 includes an elongated handle 302 with a first end 304 and a second end 306. The garden tool 300 also include a gardening head 308 configured to form a hole in a ground surface. The elongated handle 302 and the gardening head 308 can include any features of the elongated handles 102 or 202 and the gardening heads 108 or 208 as described in FIGS. 1 and 2. As depicted in FIG. 3, the gardening head 308 has an upper portion 310 that is positioned proximate the second end 306 of the elongated handle 302 and has an inverted frustum configuration. The upper portion 310 of the gardening head 308 includes a top surface 316A and a bottom surface 316B such that a surface area of the top surface 316A is greater than a surface area of the bottom surface 316B and so that an exterior surface 318 of the upper portion 310 tapers from the top surface to the bottom surface. The gardening head 308 also has a lower portion 312. The lower portion 312 of the gardening head 308 includes a rounded conical tip 314. In some embodiments, garden tool 300 also includes a grip, such as the “T”-shaped grip 320 depicted in FIG. 3.

Garden tool 300 includes a longer elongated handle 302 than garden tools 100 or 200. Garden tool 300 is therefore designed to be used by a user who is standing, rather than kneeling or sitting. As such, garden tool 300 includes a footplate 322 such that a portion of a top surface 324 of the footplate 322 is coupled to the second end 306 of the elongated handle 302 and a portion of a bottom surface 326 of the footplate 322 is coupled to the upper portion 310 of the gardening tool 308. In some embodiments, the second end 306 of the elongated handle 302 is coupled to a center of the top surface 324 of the footplate 322 and the upper portion 310 of the gardening head 308 is coupled to a center of the bottom surface 326 of the footplate 322. In some embodiments, the second end of the elongated handle 306 includes a two prong arc 328 such that the two prong arc 328 is coupled to the top surface 324 of the footplate 322 such that a center of the footplate 322 is positioned at an equal distance from each prong of the two arc prong 328.

In some embodiments, the elongated handle 302 has an adjustable length. For instance, the elongated handle 302 may include an inner structure 330 and an outer structure 332 such that at least a portion of the inner structure 330 extends inside the outer structure 332. As such, adjusting the amount of the inner structure 330 inside the outer structure 332 causes a change in length of the elongated handle 302. In some embodiments, the inner structure 330 telescopes into and out of the outer structure 332. In other embodiments, the inner structure 330 screws into and out of the outer structure 332.

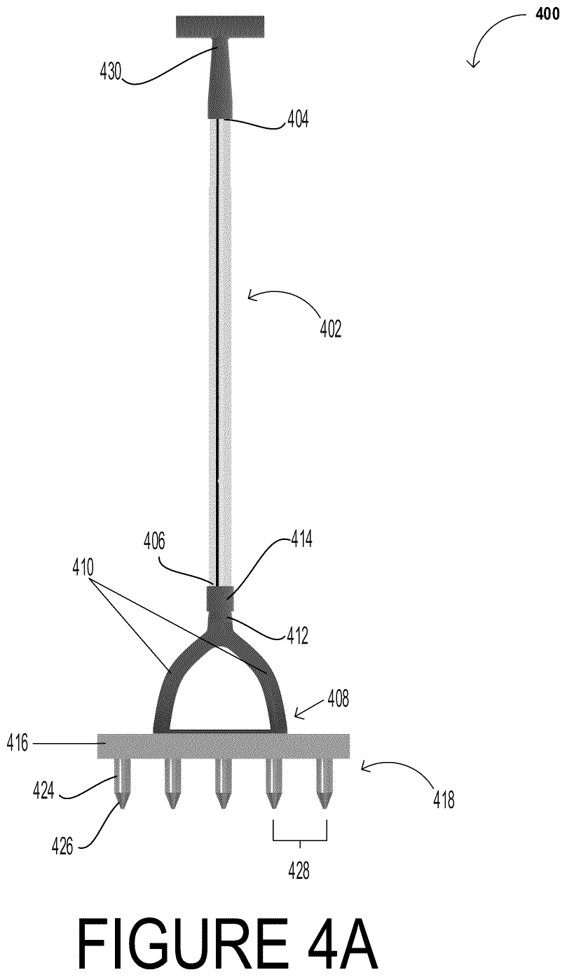

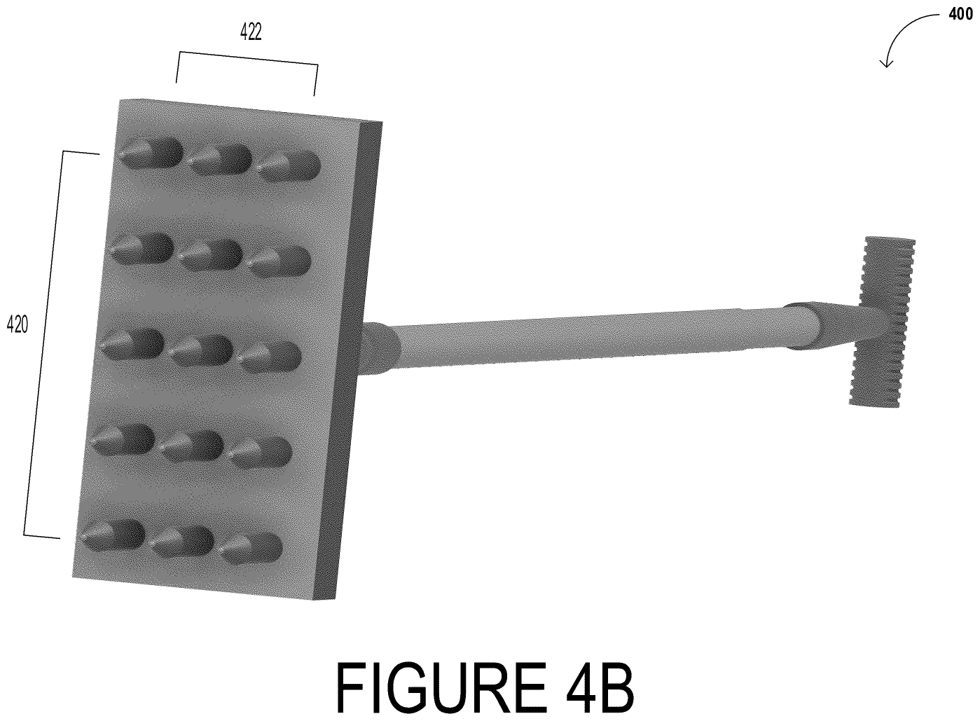

FIG. 4A depicts a garden tool 400 configured to form multiple holes concurrently. The garden tool 400 includes an elongated handle 402 with a first end 404 and a second end 406. Further, the garden tool 400 includes a footplate 408 such that the footplate 408 is coupled to the second end 406 of the elongated handle 402. In some embodiments, the second end of the elongated handle 406 includes a two prong arc 410 such that the two prong arc 410 is coupled to the footplate 408 such that a center of the footplate 408 is positioned at an equal distance from each prong of the two arc prong 410. In some embodiments, the garden tool 400 also includes a grip, such as the “T”-shaped grip 430 depicted in FIGS. 4A-4B.

Further, the garden tool 400 includes a gardening platform 416 such that the gardening platform 416 is coupled to the footplate 408. The gardening platform 416 has an array of gardening heads 418 arranged in rows 420 and columns 422 on an outer-facing surface to form an array of holes in a ground surface corresponding to the rows 420 and the columns 422 of the gardening heads 418.

Each gardening head of the array of gardening heads 418 includes a cylindrical section 424 with a rounded conical tip 426. In some embodiments, each gardening head of the array of gardening heads 418 is arranged with an equal distance 428 spaced between consecutive gardening heads of the array of gardening heads 418. The distance 428 can space consecutive gardening heads of the array of gardening heads 418 across both the rows 420 as well as the columns 422. In some embodiments, the distance 428 can be a predetermined distance (e.g., 2-5 inches apart). For instance, the distance 428 can be equal to the necessary spacing for two seeds of a certain plant that is needed for both seeds to grow appropriately. In some embodiments, the garden tool 400 can have embodiments designed for each particular plant (i.e. a garden tool 400 for use in planting garlic, a garden tool 400 for use in planting radishes, etc.).

In some embodiments, the elongated handle 402 has an adjustable length. For instance, the elongated handle 402 may include an inner structure 412 and an outer structure 414 such that at least a portion of the inner structure 412 extends inside the outer structure 414. As such, adjusting the amount of the inner structure 412 inside the outer structure 414 causes a change in length of the elongated handle 402. In some embodiments, the inner structure 412 telescopes into and out of the outer structure 414. In other embodiments, the inner structure 412 screws into and out of the outer structure 414.

FIG. 4B shows another view of the garden tool shown in FIG. 4A. As shown, the rows 420 and the columns 422 make up the array of gardening heads 418 of the garden tool 400. In the embodiment shown in FIG. 4B, there are 5 rows 420 and 3 columns 422. Other quantities of rows and columns and layouts are used for other example embodiments.

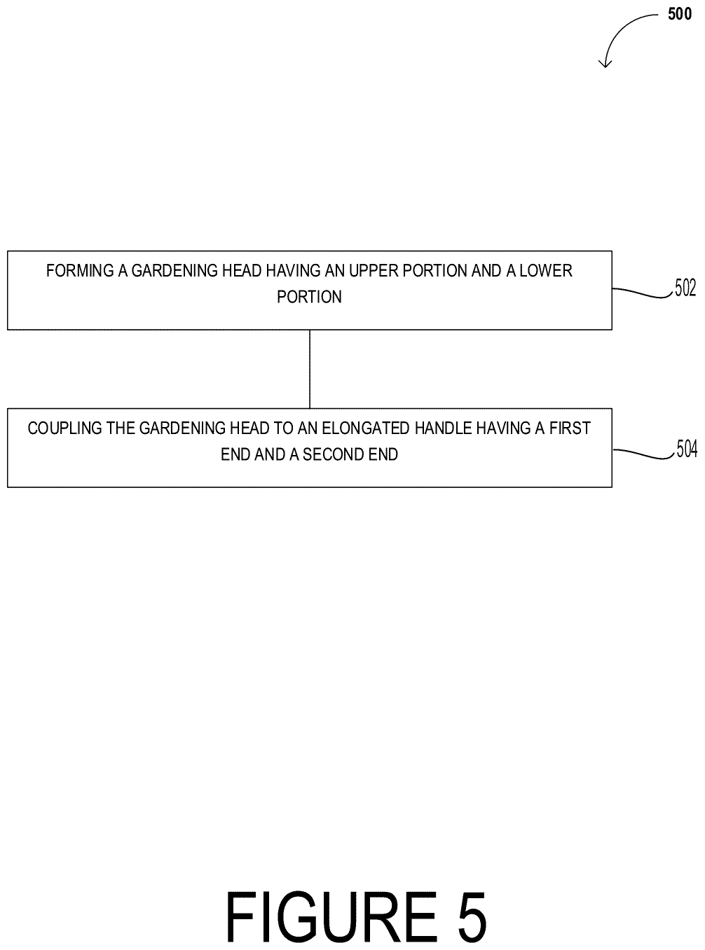

FIG. 5 depicts a method 500 of forming a garden tool, according to an example implementation. The method 500 can be used to form the garden tool 100 shown in FIG. 1, the handheld garden tool 200 shown in FIG. 2, the garden tool 300 shown in FIG. 3, and/or the garden tool 400 shown in FIGS. 4A-4B. In other examples, the method 500 can be used to generate other types of garden tools not illustrated herein. Different type of computing systems, machines, and tools can be used to perform the method 500 within examples

At block 502, the method 500 includes forming a gardening head having an upper portion and a lower portion. In some embodiments, the gardening head is formed based on the designed size and configuration of the holes that the gardening held can be used to create in a ground surface. For instance, the upper portion of the gardening head can be formed to have an inverted frustum configuration, and the lower portion of the gardening head is formed with a rounded conical tip. At block 504, the method includes coupling the gardening head to an elongated handle having a first end and a second end. In some embodiments, this occurs such that the upper portion of the gardening head is coupled proximate the second end of the elongated handle.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A garden tool comprising:
an elongated handle having a first end and a second end; and
a gardening head configured to form a hole in a ground surface,
wherein the gardening head includes an upper portion and a lower portion,
wherein the upper portion of the gardening head is positioned proximate the second end of the elongated handle and has an inverted frustum configuration, and
wherein the lower portion of the gardening head includes a rounded conical tip.

2. The garden tool of claim 1, wherein the lower portion of the gardening head includes a cylindrical section, and
wherein the cylindrical section is positioned between a bottom surface of the upper portion of the gardening head and the rounded conical tip.

3. The garden tool of claim 1, wherein the inverted frustum configuration of the upper portion of the gardening head comprises a top surface and a bottom surface, and
wherein a surface area of the top surface is greater than a surface area of the bottom surface such that an exterior surface of the upper portion tapers from the top surface to the bottom surface.

4. The garden tool of claim 3, wherein the inverted frustum configuration of the upper portion of the gardening head is a pyramidal frustum shape.

5. The garden tool of claim 3, wherein the inverted frustum configuration of the upper portion of the gardening head comprises a conical frustum shape.

6. The garden tool of claim 1, wherein a center of the elongated handle, a center of the upper portion of the gardening head, and a center of the lower portion of the gardening head are arranged in a concentric alignment.

7. The garden tool of claim 1, wherein the upper portion of the gardening head is a cuboidal structure and the elongated handle is a cylindrical structure, and
wherein a width of the cuboidal structure is greater than a diameter of the cylindrical structure.

8. The garden tool of claim 7, wherein the width of the cuboidal structure is greater than a diameter of the lower portion of the gardening head.

9. The garden tool of claim 1, wherein the upper portion of the gardening head and the lower portion of the gardening head are formed as a single-piece integral structure.

10. The garden tool of claim 1, further comprising:
a footplate, wherein a portion of a top surface of the footplate is coupled to the second end of the elongated handle and a portion of a bottom surface of the footplate is coupled to the upper portion of the gardening head.

11. The garden tool of claim 10, wherein the second end of the elongated handle is coupled at a center of the top surface of the footplate and the upper portion of the gardening head is coupled at a center of the bottom surface of the footplate.

12. The garden tool of claim 10, wherein the second end of the elongated handle includes a two prong arc, and wherein the two prong arc is coupled to the top surface of the footplate such that a center of the footplate is positioned equal distance from each prong of the two prong arc.

13. The garden tool of claim 1, wherein a length of the elongated handle is adjustable.

14. The garden tool of claim 13, wherein the elongated handle further comprises an inner structure and an outer structure,
wherein at least a portion of the inner structure extends inside the outer structure, and
wherein adjusting the portion of the inner structure causes a change in a length of the elongated handle.

15. The garden tool of claim 1, further comprising:
a grip coupled to the first end of the elongated handle.

16. The garden tool of claim 1, wherein the gardening head is made out of wood.

17. A garden tool configured to form a plurality of holes concurrently, the garden tool comprising:
an elongated handle having a first end and a second end;
a footplate, wherein a portion of a top surface of the footplate is coupled to the second end of the elongated handle; and
a gardening platform, wherein a portion of a top surface of the gardening platform is coupled to a bottom surface of the footplate, and
wherein a bottom surface of the platform includes an array of gardening heads positioned to form holes concurrently in a ground surface.

18. The garden tool of claim 17, wherein each gardening head of the array of gardening heads comprises a cylindrical section with a rounded conical tip.

19. The garden tool of claim 17, wherein the array of gardening heads are arranged with an equal distance between consecutive gardening heads of the array of gardening heads.

20. A method of forming a garden tool, the method comprising:
forming a gardening head having an upper portion and a lower portion, wherein the gardening head is configured to form a hole in a ground surface, wherein the upper portion of the gardening head is formed having an inverted frustum configuration, and wherein the lower portion of the gardening head is formed with a rounded conical tip; and
coupling the gardening head to an elongated handle having a first end and a second end, wherein the upper portion of the gardening head is coupled proximate the second end of the elongated handle.
